(19) United States
(12) Patent Application Publication
(10) Pub. No.: US 2012/0158648 A1
(43) Pub. Date: Jun. 21, 2012

(54) METHOD AND SYSTEM FOR DYNAMICALLY ROTING AN ENDITY'S ATTRIBUTE BY RECEIVING VALIDATION VALUE FROM AN ATTRIBUTE OF A QUALIFYING ENTITY

(76) Inventor: Mark Watkins, Denver, CO (US)

(21) Appl. No.: 13/138,870

(22) PCT Filed: Aug. 9, 2007
(86) PCT No.: PCT/US07/17710

§ 371 Date: Jan. 9, 2012

Related U.S. Application Data
(60) Provisional application No. 60/836,532, filed on Aug. 9, 2006.

(51) Int. Cl. G06F 17/30

(52) U.S. Cl. 707/609; 707/E17.005

(57) ABSTRACT

This invention is a method and system for dynamically rating a target entity's attribute by receiving validation value from an attribute of a qualifying source entity. The validation value involves either a user assigning weights to selected attributes or selected attributes taking weight values from attributes assigned to the user. The validation value is used for updating the rating of a target entity's attribute. Individual weighted attributes are used to define compositional attributes for things such as goods, services, ideas, terms, and quality. Compositional attributes can be comprised of supporting individual component attributes, a mix of supporting individual component attributes and supporting compositional attributes, or a mix of supporting compositional attributes. Thus, compositional attributes can also be used to support another compositional attribute. These component and weighted attributes are agreed upon by other users to form communities on the Internet by filtering content that is most relevant to the users through the use of ratings. Further, a system and method is used for qualifying attributes, both supporting and composite attributes, through transferring value from an attribute of the qualifier. The qualifying of content, goods, and services facilitates a pay subscription supported model of using relative value of content, goods, and services according to each user as a price point.

### BACKGROUND OF THE INVENTION

This method and system is related to using the Internet and other media mediums such as print media, television and radio for the qualifying of content within the media.

1. Field of Invention

This invention generally relates to methods and apparatus for using a source to qualify content in a media medium.

2. Discussion of Prior Art

Presently, the quality of content in media mediums such as the Internet suffers due to the protection of free speech with limited responsibility and the myriads of content providers which publish assertions without any enforceable checks or balances. This is due to the inability of the public to hold the members of media accountable through penalty or reparations. Moreover, the problem is coupled with the facility and accessibility that any individual has to publish content to media mediums such as the Internet.

Any user can be a journalist. The Internet enables any person that can write with the ability to easily publish content on the Internet. Due to this newness of this medium and its unregulated nature, many websites are non-validated. Impressionable youth are finding voices on the Internet that are not those of experts. For example, many people simply dabble in political movements. Many musicians dedicate the majority of their time to being rock stars, yet they try to convince young people to their own personal agendas and political beliefs even though the amount of time they spend with the issues are relatively miniscule. Outrageous claims, fictitious lies, and other fabrications can go unchallenged by the Internet community.

Any user can validate content. The problem of non-validated content is coupled with the ability of any user, anonymous or known, asserting that content is completely valid when in fact, content may be invalid. Without knowledge of the integrity of a source or the integrity of a corroborating agent, a credulous user can be lead to believe that an assertion is credible when the content is in fact fictitious. Furthermore, some content providers attempt to front proxy agents for intentional false impression in order to fool consumers of media. Lobbyist, drug companies, and other agents of questionable products have been know to use second agencies to push agendas and raise money without full transparent disclosure that theses agencies are supported by backing companies.

Furthermore, the current system of news reporting is plagued by conflict of interest. For example, the big news media outlets are owned by public corporations. If their product is news, the corporations' loyalties are to the stockholder and not the viewers who do not directly profit financially to the manipulation of the news. Thus, if a corporation's goal is to maximize profit, a conflict of interest exists because the news does not have to be fair and balance, but slanted in a way to ensure maximum value to its shareholders.

A tool is needed to prevent these companies from misleading the public for the sole benefit of financial gain. With the invention, users with proven credibility can endow their informational sources.

Spam is not validated. Internet users and users with access to email are plagued with mass marketed touts commonly known as Spam. Furthermore, intrusive advertising and so called “Pop up Advertisements” have no validation as to whether the sales pitches are reliable. A method and system is needed so users know the credibility of the spam and other such touts through transference of credibility from the source, to the messages that are being sent from the source. Furthermore, a means is needed to filter all incoming content according to user defined restrictions. Only incoming content that posses attributes within the user defined threshold of requirements should be allowed to pass to the user.

The Internet is a community without covenants. The Internet would be more useful if a community of users could filter WebPages and Internet content through a dynamic real time filter which adheres to guidelines of the community of users. For example, within the entire community of Internet users, a tool should be available to let subgroups of the community validate and prioritize content according to attributes that are in accordance with the subgroups by-laws. Thus, only a subgroup of all available WebPages, emails, etc. would be available to these sub-communities as dictated by their interest. By selecting attributes of interest and requiring minimum values of those attributes in rating web pages, those pages with a better fit towards the community's interest are validated and more highly rated.

For example, when a user is trying to find other users who are affiliated with the Republican Party, the user should have the ability to rate Internet users or web pages by defining the attribute Republican in the search for other Republicans. According to the sub component attributes that support or comprise the aggregate attribute of Republican, each returned web page or user would have a weighting of the aggregate attribute Republican. Thus, the user seeking devout Republicans could delimit their search by looking for “Republican” web pages or users with a cumulative rating of 9 or 10. The cumulative rating would be a result of the user's formula according to desired component attributes of the aggregate value Republican. These component attributes could be in the context of data within the webpage, user profile or metadata about a webpage or user.

To select more relevant users or web pages, a user would give weight or percentages to the component attributes that make up the composite attribute of their idea Republican. As an example, according to any given Republican, some attributes define a Republican more than others. A user wanting a high rating of pro-life, a low rating of pro-gay marriage, and a medium rating on pro-small government would get a personalized result of web pages according to their custom design. Lastly, by sharing and agreeing in similar mix of attributes and their weightings, sub-communities of the Internet are created according to the definition agreed upon.

A user should be able to rate political candidates and incumbents by assigning a cumulative weight to the persons by assigning subjective weights to attributes such as education, certification, or experience. Thus, a candidate can be rated according to a standard not only based on sentimental feeling (weights), but concrete value (attributes) and standards can be used to compare against the rating of other candidates, and the ratings can be shared with others.

By requiring users to agree to criteria and definition, communities within the Internet can be created with integrity. By eliminating members who are lenient on key points of belief systems such as the bible, religions, or political parties, Internet communities can retain integrity.

Furthermore, by letting users that posses high values of attributes that are key Republican values determine the criteria and definition, integrity is once again enforced. A community or community leaders can pass a community browser configured to the specification of the community.

For those users choosing not to adhere to any communities' guidelines, the Internet could be a unique experience for each of them. By assigning ratings to various component attributes of a web page, the corresponding composite attribute(s) could be displayed uniquely to the user by generating visual ratings based on the user's weighting of the components. Thus, while one user may find a composite attribute of a webpage 100% truthful, other users rating of the attribute may fall in the range of 0% -100% truthful. For example, by selecting and weighing composite attributes for an attribute such as impartial, one user may get a 100% impartial rating based on his rating system while another user may get a 25% impartial rating based on his selected and weighted rating system. An online profile composed of attributes and weights is sent with any command or navigation resulting in returned results that are custom to that profile.

In the current Internet, there are too many criterions for categorization. The Internet would be more useful if things were categorize according to user preference. Many definitions and formulas exist for any given quality, description, or measurement of an entity. For example, many different websites argue for what qualities a certain food, recipe, or dish should be in order to be certified organic. The user should be able to determine their own requirements for what they believe is organic and be able to find those items in the Internet landscape according to their custom requirements. For example, for a recipe for organic bread, the ingredients could dictate:

1 part bread, needs 0.3 parts honey and needs 0.7 parts wheat

If the ingredients had the following ratings of organic according to a group of users:

Weighted average rating of a brand of honey as organic is 8%

Weighted average rating of a brand of wheat as organic is 14%

It could be determined that using those brand of results in a bread that is 12.2% organic.

(0.3×8%)+(0.7×14%)=12.2%

Weighted average of component attribute=9.8% organic wheat

Weighted average of component attribute=2.4% organic honey

Weighted average of cumulative attribute=12.2% organic honey bread

Furthermore, if one were to make a sandwich from the 12.2% organic bread, the bread could then become a component in the making of a sandwich that will be considered so many percent organic.

Democratic voting doesn't work well when ill-informed voters influence are equal to those that are informed. The Internet is full of unsophisticated voters on certain matters. Thus, when a significant group of users who are not well versed in any particular matter vote on that matter and the community hopes for a result that is the aggregation of a multitude of well informed polling, the idea of democratic voting is compromised, for what is best for the constituents is not the outcome. Thus, a tool should be available to give more weight to votes casted by well informed voters in any particular subject matter. We need professionals to interpret their respective fields and set policies for the ordinary people who either find the world too dense and complicated to understand or prefer not to be an active member in a well-informed democracy. The Internet should be a seminal starting point for the dialogue and policy of using expert opinion to guide action and the invention provides for this infrastructure.

Terms and definitions are dynamic. A better method of understanding terms and definitions for communication purposes on the Internet is necessary or the result is in equivocal communication. Unless an entire community or a subgroup of a community can come to terms on semantics, the communication process is compromised. For example, how do two people agree on what satire is unless each person can choose and agree on which component attributes are needed or used to describe the aggregate attribute satire, and unless each person can give quantitative weight on each component that is needed to have a mutual understanding of satire.

### OBJECTS AND ADVANTAGES

Accordingly, several objects and advantages of my invention are dynamically changing ratings of a website's attributes, the prioritizing of communication and information within the Internet to form communities of similar relevancy, and more precise communicative understanding among users of the Internet.

The invention is a system and method of dynamically changing ratings of a website's attributes. The invention has the ability to use ratings attributed to a user to be considered as a factor in the outcome rating of anything that that user rates. In the current systems, a user can determine a rating by providing an opinion to a website on any content or product within the website. With the invention, the user's rating that is given to content or product is weighted according to a rating(s) that other users have given to that user. For example, a user with a low rating of an attribute such as honesty would not have very much weight in any target attribute of content or product that the user would rate. Also, anytime a change in the honesty rating of the user is changed due to other users rating the user, a dynamic down flow of change to any rating that the user has previously rated would update as well. Therefore, the user is motivated to stay honest because if he\she fabricates on any given thing and gets caught, other users can lower that user's rating(s). Thus any subsequent rating of another person, content, product or website, would holds less weight among other users with higher honesty ratings who are rating the same thing. Furthermore, anything rated before could be affected by the decrease in the user's rating.

The invention is a system and method of prioritizing communication and information transferred via the Internet. With use of the invention, communication and information available to the user can be filtered by ranking(s), the ranking(s) an outcome from the selecting and weighing of attributes according to users. Thus, users with agreed selections and weights form a subset of total users, i.e. a community of shared interests. Therefore, the community's experience of the Internet is one where email, blog information, and other Internet technologies that are engaged with or interacted with the members are relevant and customized to those members.

The invention is a system and method of providing for more precise communicative understanding among users of the Internet. The invention allows users to define ideas, definitions, and formulas for the ground work on discussions of topics that rely on those foundations. For example, in the law profession with criminal and civil proceedings, involved parties such as the prosecutor and defendant must agree on the language before any proceedings follow. The invention allows the same interaction to take place in the Internet world by providing a tool for Internet users to select attributes and weights of the attributes on ideas, definitions, and formulas as ground work for the discussion and qualifying of topics. With the invention, creativity can be preserved. Websites like wikipedia.org are about a single community of conformity, fostering a one size fits all mentality, not accounting for all professionals, or all laymen, and ignore the needs for sub cultures. On such websites, scientists are disputing things such as creationism using the scientific method and trying to impose their beliefs on scientist who are much more open to all possibilities.

Furthermore, the invention enables collaborative filtering for the use of templates for users who want to experience the Internet similarly. By community concordance on the selection of attributes and weights, the rating of content on a webpage is identical for that community of users. With this collaborative filter, users could form a community by setting a template filter to take attributes on web pages for the compiling of three rated descriptive attributes such as Original Content, Derivative Content, or Copied Content. Thus, each page the user visits would have ratings displayed according to how much of a webpage is Original Content, Derivative Content, and Copied Content. All communication and data on the Internet can be filtered according to the users so emails, blog data, etc. will only be displayed if the communication adheres to the attribute and attribute weightings selected by the users. For example, many blogs garner so much feed back that the invention could be configured to only show responses from users who have high rating of such attributes as intelligent or insightful. By user's updating metadata on any given's entity's attribute profile, the community's interest is enhanced by contributing to data the entire community can benefit from.

An additional benefit of the invention is the facilitation in enabling people to live according to their beliefs. People will often label themselves as Democrats with the mere action of voting on a Democratic candidate every four years when the presidential elections come along. These so called Democrats live this experience while performing Republican behaviors such as buying goods and services from companies that operate according to principles that are far from beliefs that many people would state as business practices in accordance to Democrat ideologies. Thus, with the invention, goods and services can have a rated aggregate attribute labeled “Democratic Product” or “Democratic Service” with the component attributes of whether the company producing the product provides a fair living wage and corresponding benefits to its employees, as well as to whether the company practices responsible environmental policies. These select component attributes would each have a weight, user or system provided, that transfers in the final weight of the rating of Democratic product. With the invention, a company's goods and services hold weighted ratings according to a company's behavior. Thus, by taking different components of a company's behavior, it could also be ascertained as to whether a product qualifies as being made in the United States or even good for the United States.

Currently, the Internet is being plagued by bots or offshore users manually clicking on ads in order to help shady web-site owners boost revenue from advertisers or aid businesses trying to drain a competitors' ad budget. The current invention discourages this behavior by tying user and content valuation to interactions on the Internet by behavior such as a click. For example, an advertiser has a vested interest in using a user's credentials in determining how much a click is worth. With the invention, an advertiser can pay per click according to a user's credibility or any such attribute. Furthermore, an advertiser can rate a user based on the user's engagement with the advertiser's content. Lastly, a user has a vested interest in keeping advertising relevant on the Internet; a community of users can rate advertisement in order to filter out companies responsible for poor advertising practices by lowering their integrity ratings so low that future advertising content does not make it pass a user's personal filter.

With the invention, professionals can determine policy and have transparency in acting according to the best policies as indicated by their industry. By setting policies for everyone based on professional opinions by those highest rated in their field of expertise, non professionals can rest assured that motivations are more relevant to the integrity of a profession. For example, educators can use human biology and human genetics to set educational standards and scientist can direct governmental policies instead lobbyist and special interests groups.

### SUMMARY OF THE INVENTION

Systems and methods consistent with the present invention address this and other needs by providing a dynamic way of continually updating ratings on the Internet by passing weight from a qualifying entity to a target being qualified for the use of generating the target's rating. An existing weight of a rated target's attributed is changed whenever a qualifying entity of the target has its own rated attributes changed.

In one aspect, the present invention is directed to a method of providing templates for users wanting to form a sub-community of the Internet. Thus, the community can either experience the Internet by having web pages modified within these templates or use the templates to filter out web pages not within the community's given template.

Further, the method qualifies users by using user information about products, music, movies, and advertising on the Internet for the building of profiles of user. Using the ratings given by the users in regards to goods and services, companies can provide customs discounts and premiums according to user profiles.

### PREFERRED EMBODIMENT

The first embodiment is a method and system for dynamically rating a web page's article by receiving validation value from attributes of a user qualifying the article. Further, it is a method and system of a pay per use model. After having a user qualify content, the user is charged according to usefulness, entertainment value, etc. as indicated on their rating of the content. After logging into a website, the service provider lets the user rate content by allowing the user to put rating weights on attributes of the content. The user is charged service fees according to how useful the user found the content and the content provider is discounted by the hosting website according to how useful the user found the content. The system combines rating information given by other users with the user's own ratings to generate an aggregate average rating of content. Users with high ratings of the attribute “credibility” have more weight in affecting the article rating than users with a lower rating of credibility. As soon as any of the users have their credibility attribute weighting changed, the change affects the weighting in any article the user has rated.

### Operation—Preferred Embodiment

The foregoing descriptions of embodiments of the present invention provide description, but are not intended to be exhaustive or to limit the invention to the precise form disclosed. Modifications and variations are possible in light of the above teachings or may be acquired from practice of the invention. For example, although the preceding description generally discusses the operation of content validation in the context of a good or service on the World Wide Web, the validation process could be managed in traditional media forms.

The invention involves components of the Internet and communication networks that access or pass information through the Internet. It should be noted that the present invention can be implemented by various other embodiments, and is not limited to the present embodiments of the invention.

In these embodiments, the method and system will mainly be described. However, as will be apparent to one having ordinary skill in the art, the present invention can be implemented as a computer-readable program. Thus, the present invention can be provided by hardware, software or a combination of hardware and software, and the program can be recorded on an arbitrary computer-readable storage medium, such as hard disk, a CD-ROM, a DVD-ROM, an optical storage device or a magnetic storage device.

Further, in the embodiments, a general computer system can be employed. The computer system for this embodiment comprises hardware resources common to average computer systems, i.e., a central processing unit (CPU), a main memory (RAM), a nonvolatile memory (ROM), a co-processor, an image accelerator, a cache memory and an input/output controller (I/O). The computer system further comprises an external memory, such as a hard disk drive, and communication means that can be connected to a network, such as the Internet. The computer system can be an arbitrary computer, such as a personal computer, a workstation, or a main frame computer.

In this rating system, a computer system of a user and a server, are connected to the Internet. The user interacts with information on a web page including goods, products, authors, companies, and articles. The user issues various request via the Internet about the interaction and the server transmits responses via the Internet to the computer system of the user. Well known browser software is installed in the computer system, and an HTTP (Hypertext Transfer Protocol) request for example, is issued from the computer system to the server. The server performs various processes, as will be explained below, and transmits, as a response, HTML (Hypertext Markup Language) data or dynamic HTML or XML (Extensible Markup Language) data.

In this embodiment, the Internet is employed; however, the use of the Internet is not always necessary. For example, the computer system and server may be connected by a special line. The Internet may be an intranet used by a company, and the communications mean for the Internet may be wired or wireless. Lastly, the embodiment could use traditional telephony technology.

An entity, herein referred to user 1, logins to a news web site, provided that user 1 has previously set up a user name and password. After reading an article, user 1 proceeds to rate various attributes of the article. User 1 is a qualifying entity. The attributes available for rating about the article could include descriptions such as political impartialness, truthfulness, and insightfulness; existing weighted ratings supporting each of the attributes may already be present. User 1 would first contribute his\her individual ratings of impartialness, truthfulness, and insightfulness on the article. These would be published next to user 1's name. Provided that other users have already rated user 1's own attributes including the attributes of impartialness, truthfulness, and insightfulness, the system uses profile information on user 1's own ratings of impartialness, truthfulness, and insightfulness in weighting user 1's contribution to the article's ratings of impartialness, truthfulness, and insightfulness for generating updated ratings of the article's attributes. These ratings would then be averaged with past users' weighted averages and the results displayed next to the article with the description impartialness, truthfulness, and insightfulness. The system uses user 1's attribute values for weighing user 1's submissions for the ratings of impartialness, truthfulness, and insightfulness, and the system would combine those weighted values with the existing weighted ratings from previous qualifiers for a new composite ratings.

For example, if user 1 submitted that the article was 100% impartial, but user 1's own impartial rating was at 80%, 80% is value that would be submitted to the existing article's rating of impartial to calculate the individual average for user 1.

To clarify, the attributes and their ratings would appear twice on the webpage. The first set is the unchanging user 1's values, values submitted by user 1 regarding his\her opinion of the article, and the second set is changing values that are composites weighted averages of all users contributing to the collective ratings. With the first set of unchanging values are weightings that arc applied to calculate the second set of changing values. The weightings are dynamic in that they are affected anytime another user, herein referred to user nth, rates user 1's attributes impartialness, truthfulness, and insightfulness. Thus, if user nth rates user 1′ rating of impartialness, thereby changing the weight, any target entity, including the article, that user 1 has rated sharing the attribute impartialness would be dynamically updated.

Provided that the website allows users to respond, comment, or add to the article that user 1 has just read, user 1 then posts his\her own feelings on the news. This post may include anything from an opinion concerning the article or the subject matters that the article discusses. Furthermore, the visible unchanging individual ratings of user 1's on the three provided attributes of the article are present. The system uses the visible unchanging rating to levy a service charge to user 1 according to user 1's unchanging ratings by debiting an existing account or by charging a financial account of user 1. Moreover, the system may use this information to discount a content provider according to the ratings offered by user 1. For example, a content provider may be provided discounts because of ancillary revenue received by engaging user 1 with the quality content provided. However, if the article was a tool for a company in an attempt to solicit a sell, the soliciting company could be charged by the hosting website just for the fact that user 1 interacted with the article.

A user with “better” credentials via ratings means an advertiser pays more per click or a user can give valuation to content just consumed and pay more money based on the utility of the content just consumed. Furthermore, any advertiser currently advertising on the webpage of such content can use the user's rating of content juxtapose to their advertising as a proof of engagement with their advertisement without the need for an actual click through on the advertisement.

All users or a sample of users that have contributed to rating the attributes results in a collective dynamic average rating on the weighted ratings of impartialness, truthfulness, and insightfulness. However, each user may not have the same affect when adding to the collective average ratings. Users with their own high ratings of impartialness, truthfulness, and insightfulness have more ability to bring the averages up, down, or maintain the average than a user possessing lower weighted ratings of impartialness, truthfulness, and insightfulness. The three composite attributes of the article could be used to generate a single overall composite rated attribute of the article called Article Value. In fact, the users could have assigned weightings to the three attributes in order to determine Article Value, for example 50% to insightfulness, 25% to truthfulness, and 25% to impartialness. Furthermore, one or more of the three attributes insightfulness, truthfulness, and impartialness could be a composite attribute from other supporting attributes that are components used to define insightfulness, truthfulness, or impartialness. The system keeps track of the all ratings that users have submitted.

Another user, herein referred to as user 2, also reads the article and user 1's response. After reading user 1's post and provided that user 2 has also logged in to the website, user 2 rates user 1 according to his\her feelings on the comments or ratings user 1 has offered, once again, using the same attributes of impartialness, truthfulness, and insightfulness. Using user 2's weights, submitted values, user 1's preexisting attributes values and past users weights and submitted values to come up with individual weighted averages for each users, the sum becomes new rated values of impartialness, truthfulness, and insightfulness of user 1. The system then proceeds to re-rate the article because it was dependent on user 1's weights and submitted ratings by updating the running composite ratings by replacing the original weighted ratings values from userl with the new weighted ratings. In effect, user 2 has adjusted the composite ratings of the article by rating user 1. However, user 1's seen ratings does not change, just the weight behind the three rated attributes in generating the seen composite ratings of the article. For the sake of fairness, it could be required that user 2 be required to offer his\her own rating and comment of the article before allowing user 2 to rate user 1, thus allowing user 1 to adjust the composite values by rating user 2. In fairness to all other users, a user may be required to rate and comment on an article before that user can rate other users who have previous rated that article. Furthermore, any new user with no ratings could start with neutral scores on his\her own attributes.

Furthermore, any composite rating that user 1 has previously rated in the community with attributes impartialness, truthfulness, and insightfulness would be affected by the change. To clarify, any change in the relevant weightings of the qualifying entity 1 due to the addition and/or change of rating of the qualifying entity 1 by another qualifying entity 2 results in the change of weight to ratings of any entity that was previously given by the first qualifying entity 1.

The running summation of a simple way of taking 10 users evaluation on a single attribute can be represented by:

$${{\sum }_{attribute\_value = m}}^{n} ( value * user\_weight ) aggregate\_attribute \_value = new\_aggregate \_attribute \_value$$

Where m represent the value submitted by the next user, n represent the value submitted by the 10^{th} user from n, and “*” represent the multiplication operator. The operand “value” represent the value submitted by the user and is first multiplied by the value “user_weight” before the product is multiplied by the operand “aggregate_attribute_value” which is the current aggregate value at the time of the user's submission. The result “new_aggregate_attribute_value” is the summation of all the users individual weighted averages.

The system would use configurable definitions such as a threshold of limitation that sets forth the maximum period of time or established event definitions as to what ratings are recalculated and are still being updated. Also, the privilege of judging or rating could be determined by randomly selecting users or some algorithm meant to give a standardized representation of the population.

### Additional Embodiment

The second embodiment is a method and system for dynamically rating a presidential candidate's quality according to attributes such as past behaviors and beliefs by receiving validation value from the assignment of percentages from a user to ranked attributes. After logging into a website, the service provider lets the user choose and rank attributes from a menu of attributes of an idea presidential candidate. The user assigns weights to each of the selected attributes according to the user's feeling of the candidate's qualification for each of the components and the system generates an overall rating of the presidential candidate.

The ideas and credibility of a candidate is largely based on the transference of sentiment and understanding from a community of voters. Thus a user could rate the candidate according to endorsements and qualities such as education or certification. A higher weight, percentage, or rank could be given to an Ivy League education as opposed to a community college education. While these could result in the composite attribute qualification being rated artificially high, adding another supporting attribute to the existing attribute mix such as past performance that is weighed heavier would result in dynamically readjusting the rating to either strengthen or weaken the cumulative rating.

In the current embodiment a user can add and subtract attributes, rank the attributes, and adjusting percentages to weigh the attributes. A slight modification of the embodiment is allowing the system, a community of users, or appointed individual to determine initial attributes and ratings. Contributing users would then apply weighting to the attributes by qualifying the attributes according to their feelings of the candidate. New behaviors of the candidate would result in the dynamic change of value.

### Additional Embodiment

The third embodiment is a method and system for dynamically tracking the attributes of a user by updating a central database or updating data on a mobile memory device each time the user is rated by the environment and other users. In this embodiment, a user chooses a memory device to hold his\hers rated attributes or holds a mobile identification that relates to the database containing the user's attributes. The memory device is capable of being read by a machine readable label reader such as RFID reader, barcode reader, card swipe reader and other devices capable of reading a machine readable label. Rated attributes continually change according to other users and evaluative entities selecting attributes and weighing them, the ratings based on judgments on the target user's interaction with the environment and other users. Thus, the central database or memory devices continually update with data to reflect changes in ratings. The environment can uses this data to interact with the user according to his\her ratings.

### Additional Embodiment

The fourth embodiment is a method of encouraging behaviors by using the invention to discriminate against content with low rated attributes. A parent selects and weights attributes to generate ratings on a corpus of content. A financial allowance is set for a child or subordinate and monies are added and subtracted from the allowance depending on which sites, content, etc. the child or subordinate interacts with. For example, for interacting with highly rated content according to the selected parental parameters, monies either remain or are added to the child's account. For visiting content lowly rated, monies could be deducted from the account.

Furthermore, by any user choosing to participate in rating content, tokens could be given in return of the effort. Credibility currency, intelligence currency, voting currency could be provided to users who submit data. Each type of rating could have an equivalent of political, corporate, religious, or academic capital that is used for the privilege of using the Internet as a platform for their choosing. Currency could be debited from an account to buy inventory space from a webpage or exchanged for goods or services. Voting currency could be used to vote people into positions of governing.

### CONCLUSION, RAMIFICATIONS, AND SCOPE

People, places, things assume validation by transference of credibility through entities describing, voting, endorsing, certifying, or rating the person, place, or thing. Furthermore, entities can provide formulas and component mixes for providing credibility by defining people, places, and things.

The qualifying entity can have means to regulate the quantity of times it can qualify a person, place, or thing's attributes. For example, the qualifying entity could possess multiple unique identifications as attributes instead of a single unique identifying attribute allowing the qualifying entity to evaluate another entity's attribute many unique times under each of the identifications.

The qualifying entity can have means to regulate the quality for each time it qualifies a person, place, or thing's attributes. For example, the qualifying entity could possess a weighted attribute such as honesty. The higher the rating of that attribute would result in allowing the qualifying entity's evaluation of a target's attributes to be more credible. Furthermore, the weighted attribute honesty could be used to weigh any target attribute due to the all encompassing nature of how important honesty is on rating any attribute or source entity weightings could be combined such as honesty and intelligence to weigh an attribute of a target entity.

The qualified entity can have means to only receive a qualifying entity's quantitative evaluation a unique number of times, preventing a forbidden redundant evaluation. For example, the qualified entity could allow a qualifying entity to evaluate its attributes several times due to the qualifying entity's condition of having many unique attributes such as those used for identification.

The qualified entity can have means to only receive a qualifying entity's qualitative evaluation within a specified range, preventing a forbidden weight outside the allowed scale range. For example, the qualified entity could allow a qualifying entity to evaluate its attributes only within a range of 1-10 while allowing another qualifying entity the ability to evaluate the qualified entity within a range of 1-20.

With the invention, web-browsers can be configured with tabs, each tab configurable to filter according to attributes and weights and aggregate score of WebPages that filter incoming WebPages. A URL click would customizes content according to the tags within the tab and the webpage reflects this customized content.

Also, other utilities could incorporate the dynamic updating of ratings to involve an entity such as a user who can tie their ratings to one or many digital identifiers. For example, through a brokering agent that monitors a user's weights and attributes, those rated attributes and weights could become portable and transferred to a yahoo login ID, to a Google login ID or to a msn login ID.

Lastly, it should be noted that the invention can work by “reverse rating” whereby heavily weighed ratings on attributes of a target entity from a current source entity can change the ratings of attributes of previous sources who had previously rated the attributes of the target entity.

What I claim is:

1. A method and system for dynamically updating an attribute value of an entity comprising:
(a) providing a source entity with at least one weighted attribute, said source entity having submitted at least one valuation to an attribute of a target entity, said attribute of the target entity having a plurality of preexisting values, said attribute of the target entity having a single preexisting value at a specific point in time, said preexisting values the result of weighted averages of a sample of entities, said sample of entities having at least one weighted attribute, said sample of entities having submitted at least one valuation to the attribute of the target entity, and
(b) means to generate individual weighted averages of the target entity's attribute, using said source entity's weighted attribute and said source entity's valuation of the target entity's attribute, using the sample of previous source entities' weighted attributes and the sample of previous source entities' valuations of the target entity's attribute, using the plurality of preexisting values of target entity's attribute, and
(c) means to generate an updated attribute value of the target entity using the individual weighted average of the source entity and using the plurality of individual weighted averages of previous source entities to calculate an updated attribute value of the target entity, whereby the attribute value of the target entity is dynamically updated, whereby the dynamically updated value of the target entity can be used as an updated source entity value to generate a weighted average of a target entity.

2. The method and system of claim 1 further including means to update at least one attribute value of a third entity using the updated attribute value of the target entity whereby a single updated value of the target entity causes at least one third entity with a dependent attribute to update.

3. The method and system of claim 2 wherein the system submits the updated target entity attribute value to a third entity using the process according to claim 1 to update an attribute value of the third entity.

4. The method and system of claim 1 wherein the preexisting value to be used to calculate the individual weighted averages is defined by predetermined rules.

5. The method and system of claim 1 wherein the preexisting value to be used to calculate the individual weighted averages is at the time of the source entity's submission of the attribute value.

6. The method and system of claim 1 wherein the preexisting value to be used to calculate the individual weighted averages is at the time of the sample of previous source entities' submission of the attribute value.

7. The method and system of claim 1 wherein the sample of entities is determined by system defined parameters for a quantity and a quality of entities to be used.

8. The method and system of claim 1 wherein the means to generate results is selected from the group comprising of a calculation, arithmetic operation, function, statistical expression, poll, test, or logs to generate individual weighted averages.

9. The method and system of claim 1 wherein the entity s selected from the group comprising of intangibles and tangibles such as a digital object, person, place, thing, product, information, concepts, or ideas.

10. The method and system of claim 1 wherein the entity is selected from the group comprising of an already existing entity or an entity created by the source entity.

11. The method and system of claim 1 further including a profile editor which rule developers create definitions for the sample of entities to be used.

12. The method and system of claim 1 further including a profile editor which rule developers create definitions for the preexisting values to be used.

13. The method and system of claim 1 wherein the source entity has means to regulate how many times it can qualify the target entity.

14. The method and system of claim 1 wherein the source entity has means to regulate the quality for each time the source entity qualifies the target entity.

15. The method and system of claim 1 wherein the target entity has means to only receive a source entity's quantitative evaluation a unique number of times, preventing a forbidden redundant evaluation.

16. The method and system of claim 1 wherein the target entity has means to only receive a qualifying entity's qualitative evaluation within a specified range, preventing a forbidden weight outside the allowed scale range.
